(19) United States
(12) Patent Application Publication
(10) Pub. No.: US 2025/0322224 A1
(43) Pub. Date: Oct. 16, 2025

(54) PHYSICAL RESERVOIR ELEMENT, PHYSICAL RESERVOIR, AND INFORMATION PROCESSING DEVICE

(71) Applicant: TDK Corporation, Tokyo (JP)

(72) Inventors: Yukio TERASAKI, Tokyo (JP); Shinichirou MOCHIZUKI, Tokyo (JP); Yukihiro URAKAWA, Tokyo (JP)

(73) Assignee: TDK Corporation, Tokyo (JP)

(21) Appl. No.: 18/636,975

(22) Filed: Apr. 16, 2024

(51) Int. Cl. G06N 3/063; G06N 3/044

(52) U.S. Cl. CPC G06N 3/063; G06N 3/044

(57) ABSTRACT

A physical reservoir element includes a first input terminal, a second input terminal, a first sample-and-hold circuit, a first output terminal, and a first nonlinear circuit. The first input terminal is connectable to an input source for transmitting an input signal to the physical reservoir. The second input terminal is connectable to one or more other physical reservoir elements. The first nonlinear circuit is disposed between the first input terminal and the first sample-and-hold circuit. A first terminal of the first sample-and-hold circuit is configured to receive a joined signal which is obtained by joining signals from the first input terminal and the second input terminal, and a second terminal of the first sample-and-hold circuit is connected to the first output terminal. The first output terminal is connectable to one or more other physical reservoir elements. The first sample-and-hold circuit holds and converts the joined signal.

### BACKGROUND OF THE INVENTION

### Field of the Invention

The present disclosure relates to a physical reservoir element, a physical reservoir, and an information processing device.

### Description of Related Art

A neuromorphic device is a device that imitates the human brain using a neural network to enable an AI or the like to efficiently perform complicated computation. A neuromorphic device artificially imitates a relationship between neurons and synapses in the human brain.

For example, a neural network includes nodes that are hierarchically arranged (neurons in the brain) and transmission means that connect the nodes (synapses in the brain). A neural network enhances a rate of correct answers to questions by training the transmission means (synapses). Training is carried out to optimize weights in the transmission means (synapses) such that a desired output is obtained.

A recurrent neural network is known as a neural network. The recurrent neural network can handle nonlinear time-series data. Nonlinear time-series data is data of which a value changes with the elapse of time, and an example thereof is stock prices. The recurrent neural network can process time-series data based on memory by feeding processed results in neurons in a subsequent layer back to neurons in a preceding layer.

Reservoir computing is a means for realizing a recurrent neural network. Reservoir computing can express complicated dynamics by causing signals to interact based on internal connections including recursive connections. Recently, for example, as described in Non Patent Document 1, realizing the concept of reservoir computing has been tried using actual devices. Application of the concept of reservoir computing to an actual device is referred to as physical reservoir computing. Physical reservoir computing is obtained by realizing nodes of a reservoir layer in mathematical reservoir computing using a device such as an electronic element which has been physically manufactured. A basic element for realizing physical reservoir computing is referred to as a physical reservoir element. A physical reservoir element is obtained by replacing nodes and the like of a reservoir layer in mathematical reservoir computing with physical electronic devices. A computation system or hardware including a reservoir layer including physical reservoir elements, an input unit for weighting an input signal, and an output unit for outputting desired information from the physical reservoir elements is referred to as a physical reservoir.

### PATENT DOCUMENTS

[Non Patent Document 1]K. Toprasertpong, E. Nako, Z. Wang, R. Nakane, M. Takenaka, and S. Takagi, “Reservoir computing on a silicon platform with a ferroelectric field-effect transistor,” Communications Engineering, 1, 21, August 2022 (DOI: 10.1038/s44172-022-00021-8)

### SUMMARY OF THE INVENTION

A physical reservoir element according to the present disclosure includes a first input terminal, a second input terminal, a first sample-and-hold circuit, a first output terminal, and a first nonlinear circuit. The first input terminal is configured to be connectable to an input source for transmitting an input signal to the physical reservoir element. The second input terminal is configured to be connectable to one or more other physical reservoir elements. The first nonlinear circuit is disposed between the first input terminal and the first sample-and-hold circuit. A first terminal of the first sample-and-hold circuit is configured to receive a joined signal which is obtained by joining signals from the first input terminal and the second input terminal, and a second terminal of the first sample-and-hold circuit is connected to the first output terminal. The first output terminal is configured to be connectable to one or more other physical reservoir elements. The first sample-and-hold circuit holds and converts the joined signal.

### BRIEF DESCRIPTION OF THE DRAWINGS

FIG. 1 is a conceptual diagram of a neural network that is imitated by a physical reservoir according to a first embodiment.

FIG. 2 is a diagram illustrating a configuration of an information processing device according to the first embodiment.

FIG. 3 is a diagram illustrating another example of the configuration of the information processing device according to the first embodiment.

FIG. 4 is a diagram illustrating a configuration of a physical reservoir according to the first embodiment.

FIG. 5 is a circuit diagram of a physical reservoir element according to the first embodiment.

FIG. 6 is a circuit diagram illustrating an example of a sample-and-hold circuit according to the first embodiment.

FIG. 7 is a diagram illustrating an operation of the sample-and-hold circuit according to the first embodiment.

FIG. 8 is a circuit diagram illustrating an example of a nonlinear circuit according to the first embodiment.

FIG. 9 is a diagram illustrating nonlinear characteristics of a physical reservoir element according to the first embodiment.

FIG. 10 is a plan view of a capacitor according to a first modified example.

FIG. 11 is a sectional view of the capacitor according to the first modified example.

FIG. 12 is a circuit diagram illustrating a sample-and-hold circuit according to a second modified example.

FIG. 13 is a circuit diagram illustrating a sample-and-hold circuit according to a third modified example.

FIG. 14 is a circuit diagram illustrating a sample-and-hold circuit according to a fourth modified example.

FIG. 15 is a circuit diagram of a physical reservoir element according to a second embodiment.

FIG. 16 is a circuit diagram of a physical reservoir element according to a third embodiment.

FIG. 17 is a circuit diagram of a physical reservoir element according to a fourth embodiment.

FIG. 18 is a circuit diagram of a physical reservoir element according to a fifth embodiment.

FIG. 19 is a circuit diagram of a physical reservoir element according to a sixth embodiment.

FIG. 20 is a diagram illustrating a configuration of a physical reservoir according to a seventh embodiment.

FIG. 21 is a diagram illustrating a configuration of a physical reservoir according to an eighth embodiment.

FIG. 22 is a diagram illustrating a configuration of a physical reservoir according to a ninth embodiment.

FIG. 23 is a diagram illustrating a configuration of a physical reservoir according to a tenth embodiment.

FIG. 24 is a diagram illustrating a configuration of a physical reservoir according to an eleventh embodiment.

FIG. 25 is a diagram illustrating a configuration of a physical reservoir according to a twelfth embodiment.

### DETAILED DESCRIPTION OF THE INVENTION

Hereinafter, embodiments of the present disclosure will be described in detail with reference to the accompanying drawings. In the drawings used for the following description, featured constituents may be conveniently enlarged for the purpose of easy understanding of features of the present disclosure, and dimensions, proportions, and the like of the constituents may be different from actual ones. Materials, dimensions, and the like exemplified in the following description are only examples, and the present disclosure is not limited thereto and can be appropriately modified within a range in which advantages of the present disclosure are achieved.

Short term memory property is one of performance metric required for a physical reservoir. The short term memory property is a criterion for determining how much past information can be stored or forgotten. In general, a physical reservoir having short term memory property optimal for a given task outputs an estimated solution by considering data in a required section of past time out of time-series data and ignoring past data older than necessary. However, when a physical reservoir is intended to realize using an electronic circuit, a physical device, or the like, there is a problem in that short term memory property thereof cannot be achieve enough. As a result, since a physical reservoir with poor short term memory property outputs an estimated solution using only most recent data in time-series data, sufficient performance is not obtained.

The present disclosure was made in consideration of the aforementioned circumstances and provides a physical reservoir element, a physical reservoir, and an information processing device with excellent short term memory property.

“First embodiment” A physical reservoir according to embodiments is the device executing mathematical reservoir computing by device. Reservoir computing is a type of a recurrent neural network.

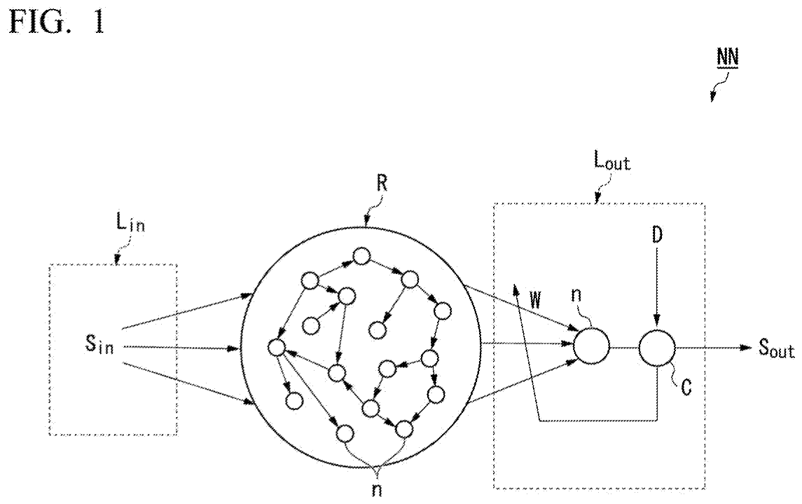

FIG. 1 is a conceptual diagram of a neural network that is imitated by a physical reservoir according to a first embodiment. A neural network NN illustrated in FIG. 1 shows the concept of reservoir computing. The neural network NN illustrated in FIG. 1 includes an input layer Lᵢₙ, a reservoir layer R, and an output layer Lₒᵤₜ. The input layer Lᵢₙ and the output layer Lₒᵤₜ are connected to the reservoir layer R.

The input layer Lᵢₙ inputs an input signal Sᵢₙ to the reservoir layer R. The input signal Sᵢₙ is, for example, a signal detected by a sensor. The input signal Sᵢₙ may be an analog signal or may be a digital signal. The input signal Sᵢₙ may include a plurality of signals. Resistors or the like which work as different weights to each input signals may be disposed in series for each input signals.

The reservoir layer R stores input signals from the input layer Lᵢₙ and converts the input signals to different signals. In the reservoir layer R, connection weights between nodes n have fixed values set by using a random number or the like, and the connection weights between nodes n are not generally trained. The input signals are nonlinearly changed by the reservoir layer R. The input signals change with the elapse of time by interacting with each other in the reservoir layer R. The reservoir layer R includes a plurality of nodes n. The nodes n correspond to neurons in a neural circuit, and connections between the nodes n correspond to synapses. In general, the plurality of nodes n are randomly connected, and the connection weights between nodes or topology may be optimized in advance and connection relationships or connection coefficients between the plurality of nodes n may be determined on the basis thereon. For example, a signal output from a certain node n at time t may return to the node n having output the signal at time t+1. The node n performs a process in consideration of the signals at time t and time t+1, and information is recursively processed.

The output layer Lₒᵤₜ receives an input of a signal from the reservoir layer R and outputs an output signal Sₒᵤₜ based on the signal. The output layer Lₒᵤₜ has weights for weighting and calculating an output of the reservoir layer R and performs an inference process using the weights. The output layer Lₒᵤₜ optimizes the weights through a learning process. In the learning process, the output layer Lₒᵤₜ compares the output of the reservoir layer R with training data D using a comparator C and adjusts weights w which are applied between the nodes n of the reservoir layer R and the nodes n of the output layer Lₒᵤₜ. The weights w are determined in the learning process. In the inference process, the output layer Lₒᵤₜ outputs an inference result based on the input signals Sᵢₙ and the weights w as the output signal Sₒᵤₜ.

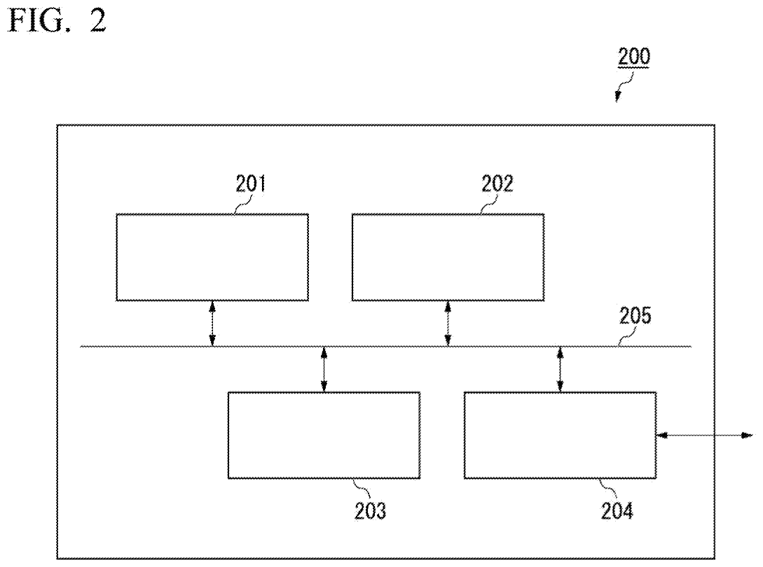

FIG. 2 is a diagram illustrating a configuration of an information processing device 200 according to the first embodiment. The information processing device 200 is hardware for operating a neural network NN.

The information processing device 200 includes, for example, a physical reservoir 201, a processor 202, a memory 203, and a communication device 204. The physical reservoir 201, the processor 202, the memory 203, and the communication device 204 are connected via a bus 205.

The physical reservoir 201 is an arithmetic device that performs processes of the neural network NN. The processor 202 executes a program stored in the memory 203. The memory 203 includes a program storage area for storing a program and an information storage area for storing information from the physical reservoir 201. The memory 203 is, for example, a dynamic random access memory (DRAM), a static random access memory (SRAM), a hard disk drive (HDD), or a solid state drive (SSD). The physical reservoir 201 performs the learning process or the inference process based on instructions from the processor 202. The communication device 204 outputs a signal to the outside of the information processing device 200. The communication device 204 may be of a wired type or a wireless type.

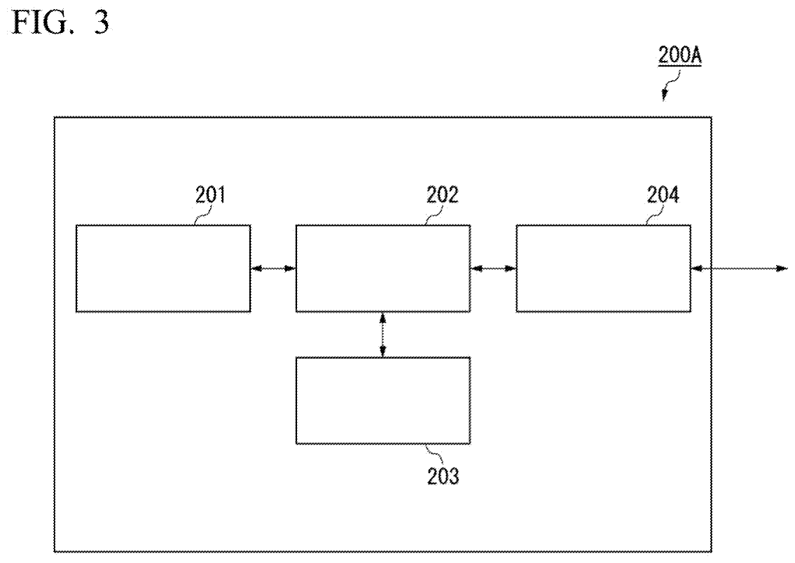

The information processing device 200 is an example of an information processing device according to the first embodiment, and the information processing device is not limited to this example. For example, FIG. 3 is a diagram illustrating another example of the configuration of the information processing device according to the first embodiment. Like the information processing device 200A illustrated in FIG. 3, the physical reservoir 201, the processor 202, the memory 203, and the communication device 204 may be connected to each other without using the bus 205.

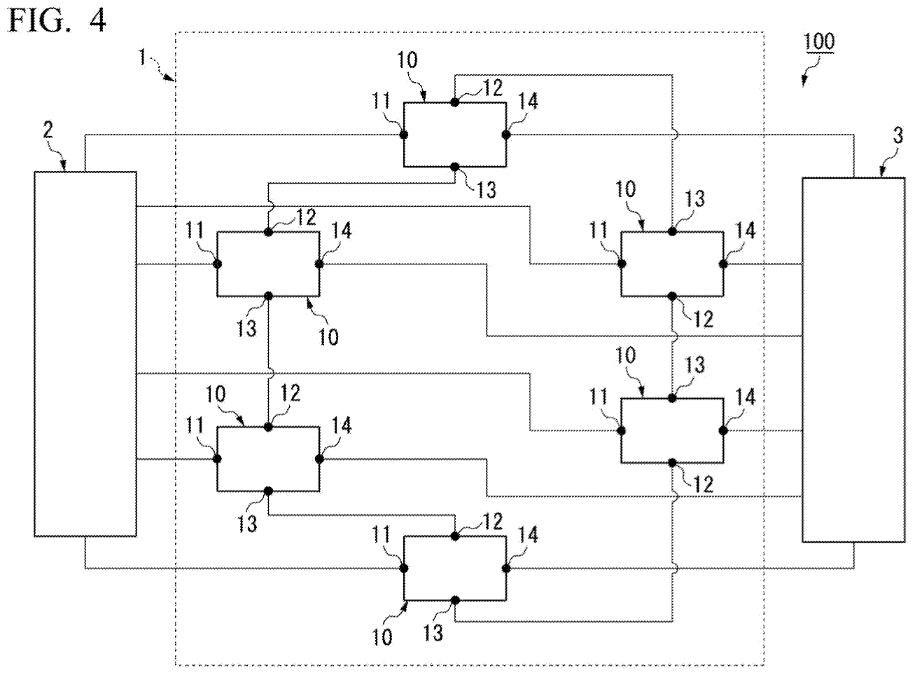

FIG. 4 is a diagram illustrating a configuration of a physical reservoir 100 according to the first embodiment. The physical reservoir 100 is an example of the physical reservoir 201, and circuits thereof perform processes of the neural network NN. In the physical reservoir 100, the concept of the mathematical neural network NN is realized using a physical device.

The physical reservoir 100 includes a reservoir 1, an input unit 2, and a read-out 3. The input unit 2 corresponds to the input layer Lᵢₙ illustrated in FIG. 1. The reservoir 1 corresponds to the reservoir layer R illustrated in FIG. 1. The read-out 3 corresponds to the output layer Lₒᵤₜ illustrated in FIG. 1. For example, when physical elements of the reservoir layer R receive analog signals as inputs, the input unit 2 includes a plurality of sensors and analog-digital converters. The read-out 3 includes, for example, an analog-digital converter, a product-sum operation circuit, a comparison circuit, and an output circuit. The processes of the read-out 3 after digital conversion in the analog-digital converter has been performed may be performed by the processor 202.

The reservoir 1 includes a plurality of physical reservoir elements 10. At least one of the physical reservoir elements 10 included in the reservoir 1 is a physical reservoir element 10 which will be described later. The number of physical reservoir elements 10 included in the reservoir 1 is not particularly limited. Each physical reservoir element 10 includes, for example, a first input terminal 11, a second input terminal 12, a first output terminal 13, and a second output terminal 14. Different physical reservoir elements 10 are connected by a line connecting the second input terminal 12 and the first output terminal 13. In the example illustrated in FIG. 4, a plurality of physical reservoir elements 10 are connected in a ring shape by lines connecting the second input terminal 12 and the first output terminal 13. The connection between the physical reservoir elements 10 illustrated in FIG. 4 is an example, and connection between the physical reservoir elements 10 and arrangement of the physical reservoir elements 10 are not limited thereto.

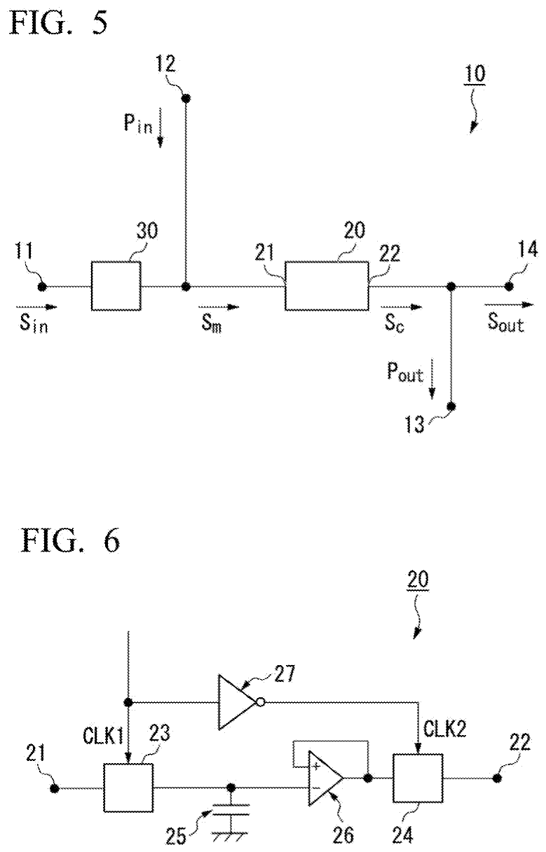

FIG. 5 is a circuit diagram of a physical reservoir element 10 according to the first embodiment. The physical reservoir element 10 includes, for example, the first input terminal 11, the second input terminal 12, the first output terminal 13, the second output terminal 14, a sample-and-hold circuit 20, and a nonlinear circuit 30. The physical reservoir element 10 may include a resistor and an amplifier in addition. The sample-and-hold circuit 20 is an example of a first sample-and-hold circuit. The nonlinear circuit 30 is an example of a first nonlinear circuit that is provided to give nonlinear conversion performance to the physical reservoir.

The first input terminal 11 is connected to, for example, the input unit 2. The input unit 2 is connected to an input source for transmitting an input signal Sᵢₙ to the physical reservoir 100. The input source is, for example, a sensor. The first input terminal 11 is configured to be connectable to the input source for transmitting the input signal Sᵢₙ to the physical reservoir 100 via the input unit 2. The input signal Sᵢₙ is input to the first input terminal 11. As the input source, a signal from a sensor with an analog output may be input to the first input terminal 11 without any change, a signal having passed through a voltage follower circuit may be input thereto, or a signal from a sensor with a digital output after being converted to an analog signal using a digital-analog converter may be input thereto. An input type of a signal to the first input terminal 11 is not particularly limited.

The second input terminal 12 is configured to be connectable to at least one other physical reservoir element 10. The second input terminal 12 is connected to, for example, the first output terminal 13 of another physical reservoir element 10. A signal Pᵢₙ from the other physical reservoir element 10 is input to the second input terminal 12.

The sample-and-hold circuit 20 holds a signal input to the sample-and-hold circuit 20 in a predetermined period and converts the signal input to the sample-and-hold circuit 20.

A first terminal 21 is a signal input terminal of the sample-and-hold circuit 20. The first terminal 21 is connected to, for example, the nonlinear circuit 30 connected to the first input terminal 11 and the second input terminal 12. A joined signal Sₘ which is obtained by joining signals from the first input terminal 11 and the second input terminal 12 is input to the first terminal 21.

Here, an output signal of the nonlinear circuit 30 is a signal based on the input signal Sᵢₙ input to the first input terminal 11 and is a signal obtained by nonlinearly converting the input signal Sᵢₙ. A signal Pᵢₙ from the second input terminal 12 may be the signal Pᵢₙ from the other physical reservoir element 10 input to the second input terminal 12 or may be a signal obtained by nonlinearly converting the signal Pᵢₙ. In the example illustrated in FIG. 5, the signal Pᵢₙ itself joins with the input signal Sᵢₙ to form the joined signal Sₘ.

A second terminal 22 is a signal output terminal of the sample-and-hold circuit 20. The second terminal 22 is connected to the first output terminal 13. The second terminal 22 may be connected to the second output terminal 14. The second terminal 22 outputs a converted signal S_{c} which is a result of conversion in the sample-and-hold circuit 20.

FIG. 6 is a circuit diagram illustrating an example of the sample-and-hold circuit 20 according to the first embodiment. The sample-and-hold circuit 20 includes a first terminal 21, a second terminal 22, a first switch 23, a second switch 24, a first capacitor 25, an amplifier 26, and an inverter 27.

The first switch 23 is disposed between the first terminal 21 and the first capacitor 25. The second switch 24 is disposed between the second terminal 22 and the first capacitor 25. A known switch can be used as the first switch 23 and the second switch 24, and for example, a MOSFET switch can be used. The first switch 23 operates with a first clock signal CLK1, and the second switch 24 operates with a second clock signal CLK2. The first clock signal CLK1 and the second clock signal CLK2 are input from the processor 202.

In the example illustrated in FIG. 6, the second clock signal CLK2 is the inverted first clock signal CLK1 by the inverter 27. Accordingly, the second switch 24 is turned off when the first switch 23 is turned on, and the first switch 23 is turned off when the second switch 24 is turned on.

The first capacitor 25 is disposed between the first switch 23 and the second switch 24. One electrode of the first capacitor 25 is connected to a line connecting the first switch 23 and the amplifier 26, and the other electrode of the first capacitor 25 is, for example, grounded. The first capacitor 25 accumulates electric charge when the first switch 23 is turned on and the second switch 24 is turned off and discharges electric charge when the first switch 23 is turned off and the second switch 24 is turned on. The amplifier 26 is connected to the first capacitor 25. The amplifier 26 amplifiers the potential of the first capacitor 25.

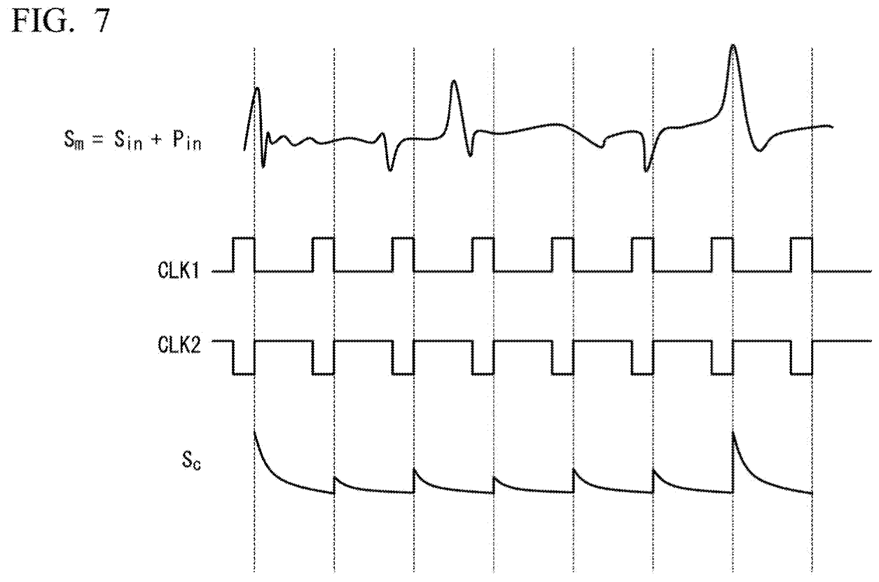

The sample-and-hold circuit 20 holds the joined signal Sₘ, converts the joined signal Sₘ to the converted signal S_{c}, and outputs the converted signal S_{c}. FIG. 7 is a diagram illustrating the operation of the sample-and-hold circuit 20 according to the first embodiment.

When the first switch 23 is turned on and the second switch 24 is turned off, the joined signal Sₘ reaches the first capacitor 25. The first capacitor 25 accumulates electric charge based on the joined signal Sₘ. That is, the joined signal is held by the first capacitor 25 in a predetermined time.

Subsequently, when the first switch 23 is turned off and the second switch 24 is turned on, the electric charge accumulated in the first capacitor 25 is discharged. At this time, the joined signal Sₘ is converted to a signal of discrete time which is the converted signal S_{c}. The amplifier 26 amplifies a signal based on the electric charge accumulated in the first capacitor 25.

Since the joined signal Sₘ is held in the first capacitor 25 in a predetermined period and the sample-and-hold circuit 20 is controlled such that a signal held by a next physical reservoir element propagates, the sample-and-hold circuit 20 enhances short term memory property of the physical reservoir 100. The next physical reservoir is a physical reservoir connected to a control signal for controlling the first switch 23 and the second switch in a next cycle. Since the joined signal Sₘ is nonlinearly converted to the converted signal S_{c}, the sample-and-hold circuit 20 contributes to nonlinear conversion performance of the physical reservoir 100. The first clock signal CLK1 and the second clock signal CLK2 may not have to have a duty ratio of 50:50, and the duty ratio can be freely designed.

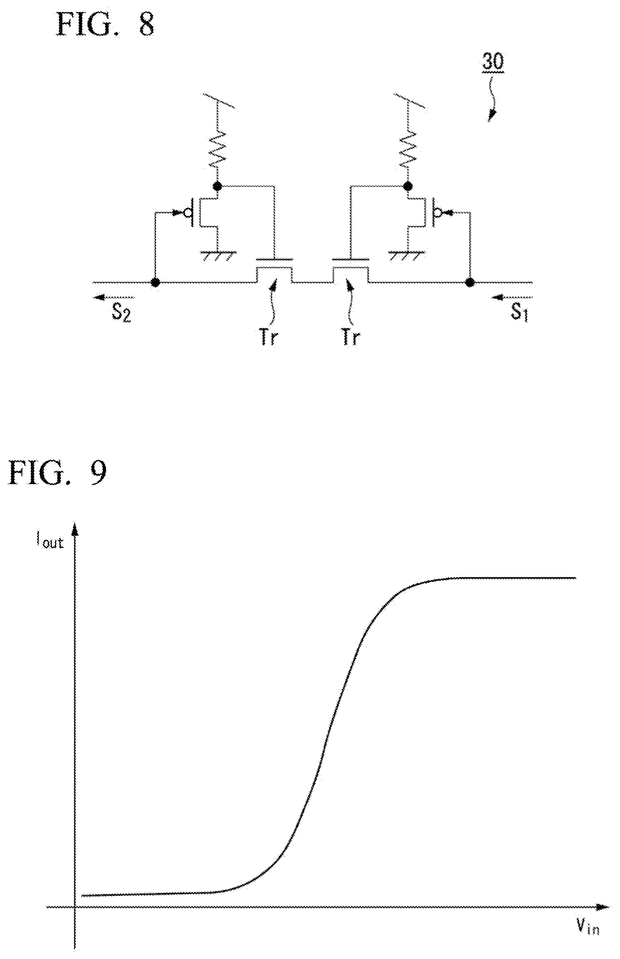

The nonlinear circuit 30 is connected to the first input terminal 11 and the first terminal 21 of the sample-and-hold circuit 20. The nonlinear circuit 30 is, for example, a horizontal resistance circuit. FIG. 8 is a circuit diagram illustrating an example of the nonlinear circuit 30 according to the first embodiment. The nonlinear circuit 30 is not limited to the example illustrated in FIG. 8, and, for example, only a left half or a right half of a circuit with symmetry illustrated in FIG. 8 may be used as the nonlinear circuit.

The nonlinear circuit 30 converts a first signal S₁ to a second signal S₂ nonlinearly and outputs the second signal. The second signal S₂ and the first signal S₁ satisfy, for example, a relational expression y≠ax+b. In this relational expression, y is the second signal S₂, x is the first signal S₁, and a and b are arbitrary values. The first signal S₁ is the input signal Sᵢₙ.

The nonlinear circuit 30 enhances nonlinear performance of the physical reservoir 100. The reservoir 1 projects an input signal Sᵢₙ to a nonlinear space, and an expressive ability of the physical reservoir 100 increases as the nonlinearity of signal conversion in the reservoir 1 increases. Even when the physical reservoir element 10 does not include the nonlinear circuit 30, nonlinear conversion occurs by the sample-and-hold circuit 20, and thus the nonlinear circuit 30 is not essential for the physical reservoir element 10. However, when the physical reservoir element 10 includes the nonlinear circuit 30, the physical reservoir 100 can process more complex signals.

The nonlinear characteristics of the nonlinear circuit 30 can be changed by changing a gate length, a gate width, and a gate voltage of a transistor Tr included in the nonlinear circuit 30.

It is preferable that the plurality of physical reservoir elements 10 included in the physical reservoir 100 have different nonlinear characteristics. For example, the nonlinear characteristics of the nonlinear circuit 30 in at least one of the plurality of physical reservoir elements 10 are different from the nonlinear characteristics of the nonlinear circuit 30 in another physical reservoir element 10 out of the plurality of physical reservoir elements 10.

The nonlinear characteristics represent a degree of nonlinearity between an input and an output. When the second signal S₂ and the first signal S₁ satisfy the relational expression y≠ax+b, they satisfy a nonlinear relationship, and the nonlinear relationship have various types. For example, a function which is expressed as an exponential function, a logarithmic function, a sinusoidal function, or a high-order polynomial is also a nonlinear function, and a combination thereof is also a nonlinear function. When the nonlinear characteristics of the plurality of physical reservoir elements 10 deviate, the degrees of nonlinear conversion in the physical reservoir elements 10 are not constant, but the degrees of nonlinear conversion in the physical reservoir elements 10 are different. When the degrees of nonlinear conversion in the physical reservoir elements 10 are different, a slope of a resistance change with an applied voltage varies, a resistance saturation method varies, or an offset serving as a reference for a resistance change varies, for example, for the physical reservoir elements 10.

The first output terminal 13 is configured to be connectable to at least one other physical reservoir element 10. The first output terminal 13 is connected to, for example, the second input terminal 12 of the other physical reservoir element 10. A signal Pₒᵤₜ is output from the first output terminal 13 to the other physical reservoir element 10. The input signal Sᵢₙ from the first input terminal 11 and the signal Pᵢₙ from the second input terminal 12 are converted to the signal Pont while the signals are propagating in the physical reservoir element 10.

The second output terminal 14 is configured to be connectable to the read-out 3. In the physical reservoir 100, the second output terminal 14 is connected to the read-out 3. An output signal output from the second output terminal 14 is output to the outside via the read-out 3.

In the physical reservoir 100 according to the first embodiment, a plurality of physical reservoir elements 10 are connected, and signals interact with each other while being nonlinearly converted between the physical reservoir elements 10. FIG. 9 is a graph illustrating a measurement result of nonlinear conversion characteristics of the nonlinear circuit 30 according to the first embodiment. The horizontal axis of FIG. 9 represents a voltage Vᵢₙ, corresponding to the signal input to the nonlinear circuit 30. The vertical axis of FIG. 9 represents a current Iout corresponding to the signal output from the nonlinear circuit 30. As illustrated in FIG. 9, the signal output from the nonlinear circuit 30 nonlinearly converts the signal input to the nonlinear circuit 30. The physical reservoir 100 has implemented a structure of a neural network NN by a physical circuit (hardware) therein, not by software.

In the physical reservoir 100 according to the first embodiment, an input signal Sᵢₙ from the input unit 2 is input to each of a plurality of physical reservoir elements 10, and the input signal Sᵢₙ is held in the sample-and-hold circuit 20 thereof in a predetermined period. Holding the input signal Sᵢₙ for a predetermined period means that past information is held in the physical reservoir 100. That is, the physical reservoir 100 according to the first embodiment has excellent short term memory property. The short term memory property of the physical reservoir 100 using the physical reservoir element 10 illustrated in FIG. 5 was 60. On the other hand, the short term memory property of a physical reservoir using a physical reservoir element obtained by excluding the sample-and-hold circuit 20 from the physical reservoir element 10 illustrated in FIG. 5 was 15. Since the physical reservoir element 10 includes the sample-and-hold circuit 20, it can be confirmed that the short term memory property of the physical reservoir 100 can be enhanced.

An example of the physical reservoir 100 according to the first embodiment has been described above in detail, and the physical reservoir according to the first embodiment can be modified and altered in various forms within the range of the gist of the present disclosure.

For example, the first capacitor 25 illustrated in FIG. 6 is a capacitor with a constant capacitance, but the first capacitor 25 may be a variable capacitor of which a capacitance is variable. In the following description, it is assumed that the first capacitor 25 is a variable capacitor.

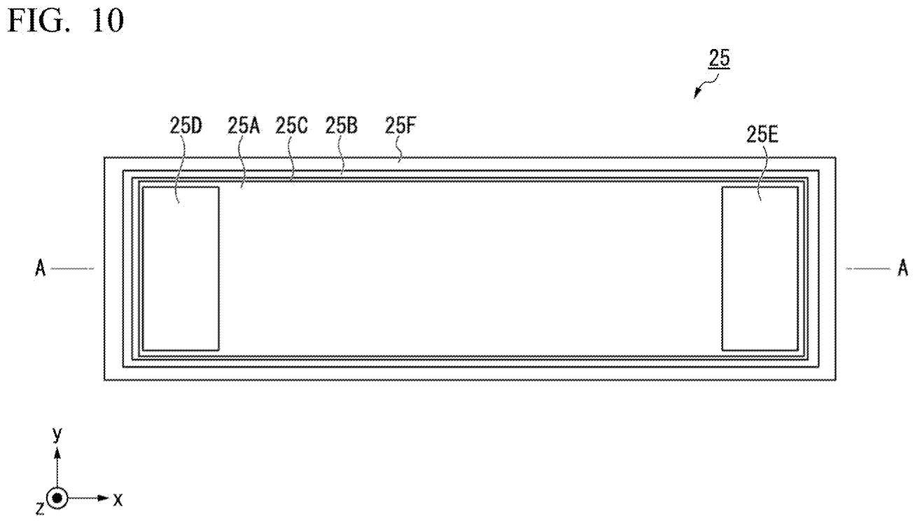

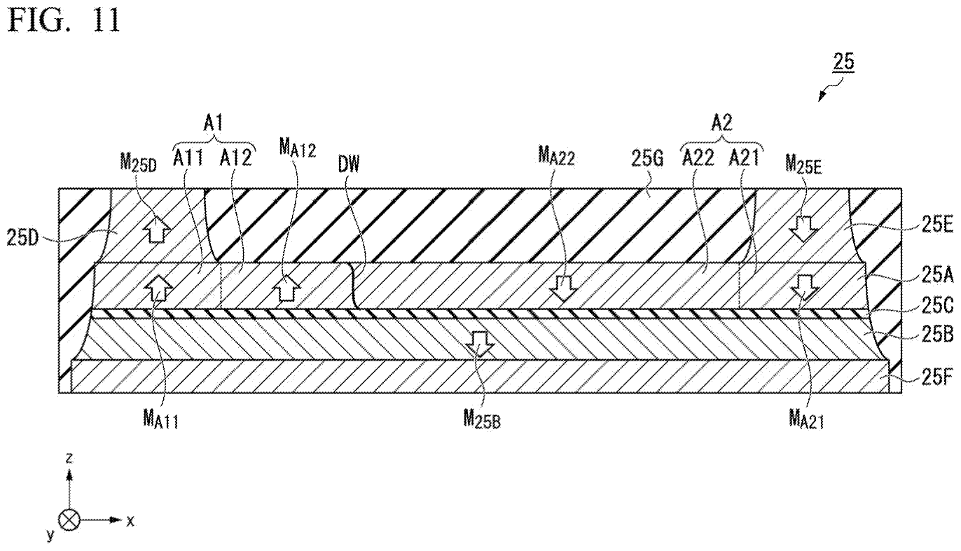

FIG. 10 is a plan view of a first capacitor according to a first modified example. FIG. 11 is a sectional view of the first capacitor according to the first modified example. The first capacitor 25 includes a first conductive layer 25A, a second conductive layer 25B, a capacitance layer 25C, a first electrode 25D, a second electrode 25E, and a third electrode 25F. A conductance of the first capacitor 25 changes with change in magnetization of the first conductive layer 25A and the second conductive layer 25B interposing the capacitance layer 25C therebetween. The first capacitor 25 is covered by, for example, an insulating layer 25G.

The first conductive layer 25A is a ferromagnetic layer including a ferromagnetic material. The first conductive layer 25A may be a ferromagnetic layer formed of a ferromagnetic material.

Examples of the ferromagnetic material include a metal selected from a group consisting of Cr, Mn, Co, Fe, and Ni, an alloy including one or more kinds of the metals, and alloys including at least one element of B, C, and N along with the metals. The ferromagnetic material may include, for example, one selected from a group consisting of a CoPt alloy, a CoNi alloy, a TbFeCo alloy, a CoFe alloy, and an alloy formed by replacing a part of the alloy. The ferromagnetic material is, for example, Co—Fe, Co—Fe—B, or Ni—Fe.

The ferromagnetic material may be, for example, a Heusler alloy. The Heusler alloy is a half-metal and has high spin polarizability. The Heusler alloy is an intermetallic compound having a chemical composition of XYZ or X₂YZ, where X is a noble metal element or a transition metal element such as Co, Fe, Ni, or group Cu in the periodic table, Y is a transition metal such as Mn, V, Cr, or group Ti or the element of X, and Z is a typical element of group III to group V. Examples of the Heusler alloy include Co₂FeSi, Co₂FeGe, Co₂FeGa, Co₂MnSi, Co₂Mn₁₋ₐFeₐAl_{b}Si_{1-b}, and Co₂FeGe_{1-c}Ga_{c}.

The first conductive layer 25A includes a first magnetic domain A1 and a second magnetic domain A2. A magnetic domain wall DW is at a boundary between the first magnetic domain A1 and the second magnetic domain A2.

The magnetic domain wall DW is configured to be movable in at least an area of the first conductive layer 25A overlapping the capacitance layer 25C in a stacking direction in a first direction in the plane of the first conductive layer 25A. For example, the magnetic domain wall DW is configured to be movable in an x direction in the first conductive layer 25A. The x direction is one direction in the plane in which layers extend. Ay direction is a direction perpendicular to the x direction in the plane in which layers extend. A z direction is a direction perpendicular to the x direction and the y direction.

The magnetic domain wall DW moves in the x direction by changing a potential difference between the first electrode 25D and the second electrode 25E. The magnetic domain wall DW moves, for example, by applying a writing current (for example, a current pulse) in the x direction of the first conductive layer 25A or applying an external magnetic field to the first conductive layer 25A. For example, when a writing pulse is applied between the first electrode 25D and the second electrode 25E, the magnetic domain wall DW moves.

The first magnetic domain A1 includes a first area A11 and a second area A12. Magnetization in the first magnetic domain A1 is oriented in the same direction. Magnetization M_{A11} in the first area A11 and magnetization M_{A12} in the second area A12 are oriented in the same direction.

The first area A11 is an area overlapping the first electrode 25D when seen in the z direction and an area in which the magnetization M_{A11} is fixed. Fixation of magnetization means that the magnetization is not inverted in a normal operation of the first capacitor 25 (an external force greater than supposed is not applied). The first area A11 is referred to as a first magnetization-fixed area.

The second area A12 is an area other than the first area A11 in the first magnetic domain A1. A volume of the second area A12 changes with movement of the magnetic domain wall DW.

The second magnetic domain A2 includes a third area A21 and a fourth area A22. Magnetization in the second magnetic domain A2 is oriented in the same direction. The magnetization in the second magnetic domain A2 is oriented in a direction different from the magnetization in the first magnetic domain A1. Magnetization M_{A21} in the third area A21 and magnetization M_{A22} in the fourth area A22 are oriented in the same direction.

The third area A21 is an area overlapping the second electrode 25E when seen in the z direction and an area in which the magnetization M_{A21} is fixed. The third area A21 is referred to as a second magnetization-fixed area.

The fourth area A22 is an area other than the third area A21 in the second magnetic domain A2. A volume of the fourth area A22 changes with movement of the magnetic domain wall DW.

The second area A12 and the fourth area A22 are referred to as a magnetic domain wall moving area. The magnetic domain wall moving area is interposed between the first magnetization-fixed area and the second magnetization-fixed area.

The second conductive layer 25B is in contact with the capacitance layer 25C. The first conductive layer 25A and the second conductive layer 25B interpose the capacitance layer 25C therebetween.

The second conductive layer 25B is a ferromagnetic layer including a ferromagnetic material. The second conductive layer 25B may be a ferromagnetic layer formed of a ferromagnetic material. The same material as the material of the first conductive layer 25A can be used for the second conductive layer 25B. The material of the second conductive layer 25B and the material of the first conductive layer 25A may be the same or different from each other. Magnetization M_{25B} of the second conductive layer 25B is less likely to be inverted than magnetization of the first conductive layer 25A.

The capacitance layer 25C is interposed between the first conductive layer 25A and the second conductive layer 25B. The capacitance layer 25C is a dielectric layer. The capacitance layer 25C has insulating characteristics, and electric charge is accumulated in the first conductive layer 25A and the second conductive layer 25B interposing the capacitance layer 25C therebetween.

The capacitance layer 25C includes, for example, one selected from a group consisting of magnesium oxide (MgO), aluminum oxide (Al₂O₃), titanium oxide (TiO₂), barium titanate (BaTiO₃), magnesium aluminate (MgAl₂O₄), silicon oxide (SiO₂), magnesium titanate (MgTiO₃), and hafnium oxide (HfO₂). Composition ratios of elements in these oxides are not limited to stoichiometric compositions. When the capacitance layer 25C includes these materials, a change width in capacitance of the first capacitor 25 becomes greater.

For example, the capacitance layer 25C may include aluminum nitride (AlN) or a material in which one selected from a group consisting of calcium, strontium, titanium, and potassium is added to the aluminum nitride. When the capacitance layer 25C includes these materials, the capacitance thereof can be increased. When the capacitance layer 25C includes these materials, electric conductivity of the capacitance layer 25C can be improved to curb heating due to supply of electric power. As a result, it is possible to curb a large change of the temperature of the first capacitor 25 in use.

The capacitance layer 25C may include one selected from a group consisting of lead titanate (PbTiO₃), strontium titanate (SrTiO₃), lead zirconate (PbZrO₃), tin hafnate (PbHfO₃), and relaxor ferroelectrics. When the capacitance layer 25C includes these materials, a dielectric constant of the capacitance layer 25C becomes greater and the capacitance of the first capacitor 25 becomes greater.

The first electrode 25D and the second electrode 25E are, for example, ferromagnetic layers. For example, the same material as the first conductive layer 25A and the second conductive layer 25B can be used for the first electrode 25D and the second electrode 25E. The third electrode 25F is in contact with the second conductive layer 25B. The third electrode 25F is a conductor.

The capacitance of the first capacitor 25 changes by applying a potential difference between the first electrode 25D and the second electrode 25E and applying a writing current (a writing pulse) to the first conductive layer 25A. The capacitance of the first capacitor 25 changes in an analog manner by applying an electrical signal in one direction in the plane of the first conductive layer 25A.

The writing current (the writing pulse) moves in the magnetic domain wall DW in the first conductive layer 25A. The position of the magnetic domain wall DW changes according to the magnitude of the writing current (the writing pulse).

The capacitance of the first capacitor 25 increases as the area in which the magnetization M_{25B} of the second conductive layer 25B and the magnetization of the first conductive layer 25A are anti-parallel to each other increases and decreases as the area in which the magnetization M_{25B} of the second conductive layer 25B and the magnetization of the first conductive layer 25A are parallel to each other increases. The capacitance of the first capacitor 25 increases as the first magnetic domain A1 is widened, and the capacitance of the first capacitor 25 decreases as the second magnetic domain A2 is widened. For example, the capacitance of the first capacitor 25 changes between 1 μF and 1 pF.

When the capacitance of the first capacitor 25 is variable, it is possible to change the short term memory property according to a task given to the physical reservoir 100. For example, when estimation accuracy is higher by considering older data out of time-series data, it is possible to enhance the short term memory property by increasing the capacitance of the first capacitor 25.

The configuration of the sample-and-hold circuit 20 is not limited to the configuration illustrated in FIG. 6.

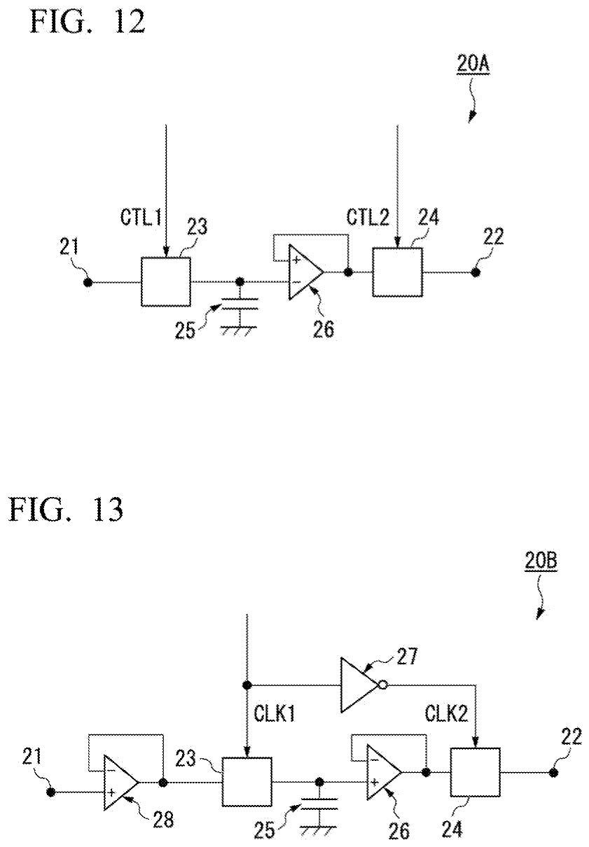

FIG. 12 is a circuit diagram of a sample-and-hold circuit 20A of a physical reservoir according to a second modified example. The sample-and-hold circuit 20A is different from the sample-and-hold circuit 20 illustrated in FIG. 6 in that the inverter 27 is not provided.

In the sample-and-hold circuit 20A, turning-on/off of the first switch 23 and the second switch 24 are controlled by inputting control signals thereto. The first control signal CTL1 for controlling turning-on/off of the first switch 23 and the second control signal CTL2 for controlling turning-on/off of the second switch 24 are separately input. The first control signal CTL1 and the second control signal CTL2 are independently variable.

When the second control signal CTL2 and the first control signal CTL1 are separately controlled, the duty ratios of the first control signal CTL1 and the second control signal CTL2, the frequencies of the first control signal CTL1 and the second control signal CTL2, and the like are variable. A holding time during which a joined signal Sₘ is held in the sample-and-hold circuit 20A changes according to the turning-on and turning-off timings of the first switch 23 and the second switch 24. By adjusting the holding time, the timings at which the signal is held, and the like, it is possible to adjust the short term memory property of the physical reservoir.

FIG. 13 is a circuit diagram of a sample-and-hold circuit 20B of a physical reservoir according to a third modified example. The sample-and-hold circuit 20B is different from the sample-and-hold circuit 20 illustrated in FIG. 6 in that a voltage follower circuit 28 is disposed between the first terminal 21 and the first switch 23.

The sample-and-hold circuit 20B can separate circuits by the voltage follower circuit 28. The sample-and-hold circuit 20B can perform signal processing with higher accuracy by cutting off signals from circuits in a subsequent stage.

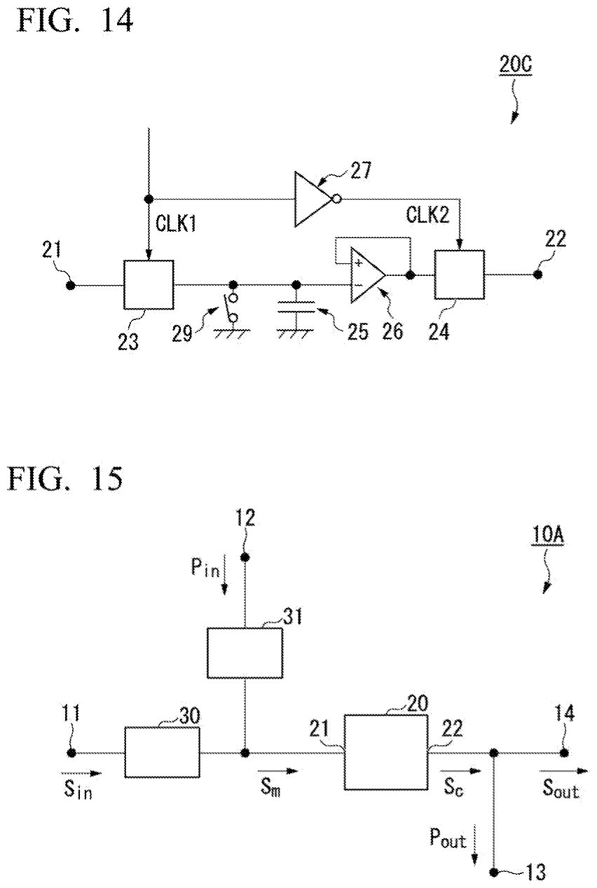

FIG. 14 is a circuit diagram of a sample-and-hold circuit 20C of a physical reservoir according to a fourth modified example. The sample-and-hold circuit 20C is different from the sample-and-hold circuit 20 illustrated in FIG. 6 in that a switch 29 is disposed between the first switch 23 and the first capacitor 25. The switch 29 can employ a known switch, and an example thereof is a MOSFET switch. When the switch 29 is turned on, electric charge accumulated in the first capacitor 25 is fully discharged. The sample-and-hold circuit 20C can control an amount of electric charge remaining in the first capacitor 25 by turning on or off the switch 29.

The characteristic configurations according to the first to fourth modified examples may be combined. For example, the first capacitors 25 according to the second to fourth modified examples may employ a variable capacitor. For example, the amplifier 28 or the switch 29 may be provided in the sample-and-hold circuit 20A according to the first modified example. For example, the switch 29 may be provided in the sample-and-hold circuit 20B according to the second modified example.

### Second Embodiment

FIG. 15 is a circuit diagram of a physical reservoir element 10A of a physical reservoir according to a second embodiment. The physical reservoir element 10A according to the second embodiment can be replaced with the physical reservoir element 10 of the physical reservoir 100 according to the first embodiment. The physical reservoir element 10A is different from the physical reservoir element 10 according to the first embodiment in that a nonlinear circuit 31 is disposed. In the physical reservoir element 10A, the same elements as in the physical reservoir element 10 will be referred to by the same reference signs and description thereof will be omitted.

The nonlinear circuit 31 is connected to the second input terminal 12 and the first terminal 21 of the sample-and-hold circuit 20. The nonlinear circuit 31 is an example of a second nonlinear circuit. The nonlinear circuit 31 is the same circuit as the nonlinear circuit 30 and is, for example, a horizontal resistance circuit. The nonlinear circuit 31 nonlinearly converts a signal input to the nonlinear circuit 31 and outputs the resultant signal.

The nonlinear circuit 31 enhances the nonlinear characteristics of a physical reservoir. In reservoir computing, it is known that each node has various types of nonlinear conversion ability and thus an expressive ability thereof in reservoir computing is increased. Accordingly, as nonlinear performance or diversity of signal conversion of the physical reservoir element increases, the expressive power of the physical reservoir increases.

Similarly to the nonlinear circuit 30, nonlinear characteristics of the nonlinear circuit 31 can be changed by changing a gate length, a gate width, and a gate voltage of a transistor Tr included in the nonlinear circuit 31. In the physical reservoir elements 10A included in the physical reservoir, the nonlinear characteristics of the nonlinear circuits 31 may be the same or different from each other.

In the physical reservoir according to the second embodiment, a plurality of physical reservoir elements 10A are connected, and signals interact with each other while the signals are nonlinearly converted in the physical reservoir elements 10A. In the plurality of physical reservoir elements 10A, the sample-and-hold circuit 20 can hold an input signal in a predetermined period. The physical reservoir 100 according to the second embodiment has excellent short term memory property similarly to the physical reservoir 100 according to the first embodiment.

The physical reservoir element 10A according to the second embodiment can employ the same modified examples as in the physical reservoir element 10 according to the first embodiment.

### Third Embodiment

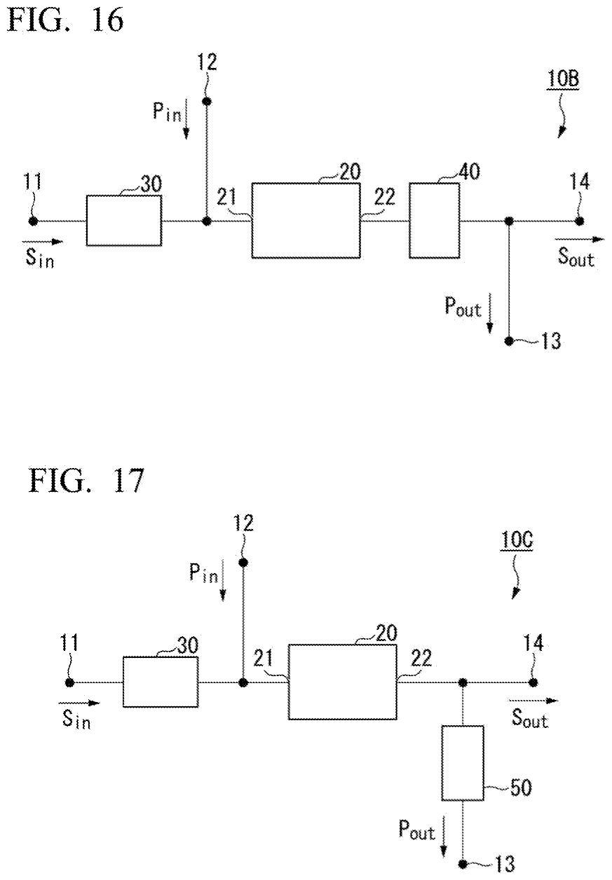

FIG. 16 is a circuit diagram of a physical reservoir element 10B of a physical reservoir according to a third embodiment. The physical reservoir element 10B according to the third embodiment can be replaced with the physical reservoir element 10 of the physical reservoir 100 according to the first embodiment. The physical reservoir element 10B is different from the physical reservoir element 10 according to the first embodiment in that a sample-and-hold circuit 40 is disposed. In the physical reservoir element 10B, the same elements as in the physical reservoir element 10 will be referred to by the same reference signs and description thereof will be omitted.

The sample-and-hold circuit 40 is connected to the sample-and-hold circuit 20 and the first output terminal 13 or the second output terminal 14. The sample-and-hold circuit 40 is an example of a second sample-and-hold circuit. The sample-and-hold circuit 40 is, for example, a capacitor. One electrode of the capacitor is connected between a junction of a line between the first output terminal 13 and the second output terminal 14 and the second terminal 22 of the sample-and-hold circuit 20. The other electrode of the capacitor is, for example, grounded.

The sample-and-hold circuit 40 accumulates a part of a signal output from the second terminal 22 of the sample-and-hold circuit 20. Since the sample-and-hold circuit 40 holds of a part of the signal, it is possible to enhance short term memory property of the physical reservoir.

The physical reservoir according to the third embodiment has excellent short term memory property similarly to the physical reservoir 100 according to the first embodiment.

The physical reservoir element 10B according to the third embodiment can also employ the same modified examples as in the physical reservoir element 10 according to the first embodiment. The nonlinear circuit 31 according to the second embodiment may be applied to the physical reservoir element 10B according to the third embodiment.

### Fourth Embodiment

FIG. 17 is a circuit diagram of a physical reservoir element 10C of a physical reservoir according to a fourth embodiment. The physical reservoir element 10C according to the fourth embodiment can be replaced with the physical reservoir element 10 of the physical reservoir 100 according to the first embodiment. The physical reservoir element 10C is different from the physical reservoir element 10 according to the first embodiment in that an output adjusting unit 50 is disposed. In the physical reservoir element 10C, the same elements as in the physical reservoir element 10 will be referred to by the same reference signs and description thereof will be omitted.

The output adjusting unit 50 is connected to the second terminal 22 of the sample-and-hold circuit 20 and the first output terminal 13. The output adjusting unit 50 changes the intensity of a signal Pₒᵤₜ reaching the first output terminal 13. For example, the output adjusting unit 50 decreases or increases the intensity of the signal Pₒᵤₜ reaching the first output terminal 13.

The output adjusting unit 50 is, for example, a resistor. The output adjusting unit 50 may be a gain adjustment circuit. The gain adjustment circuit includes, for example, an amplifier and an attenuator. The output adjusting unit 50 changes connection between the physical reservoir elements 10C by changing the intensity of the signal Pₒᵤₜ. Connection between the physical reservoir elements 10C is a parameter affecting short term memory property of the physical reservoir. It is possible to change the short term memory property of the physical reservoir by adjusting the connection between the physical reservoir elements 10C.

The physical reservoir according to the fourth embodiment has excellent short term memory property similarly to the physical reservoir 100 according to the first embodiment.

The physical reservoir element 10C according to the fourth embodiment can also employ the same modified examples as in the physical reservoir element 10 according to the first embodiment. To the physical reservoir element 10C according to the fourth embodiment, the nonlinear circuit 31 according to the second embodiment may be applied, the sample-and-hold circuit 40 according to the third embodiment may be applied, or both thereof may be applied.

### Fifth Embodiment

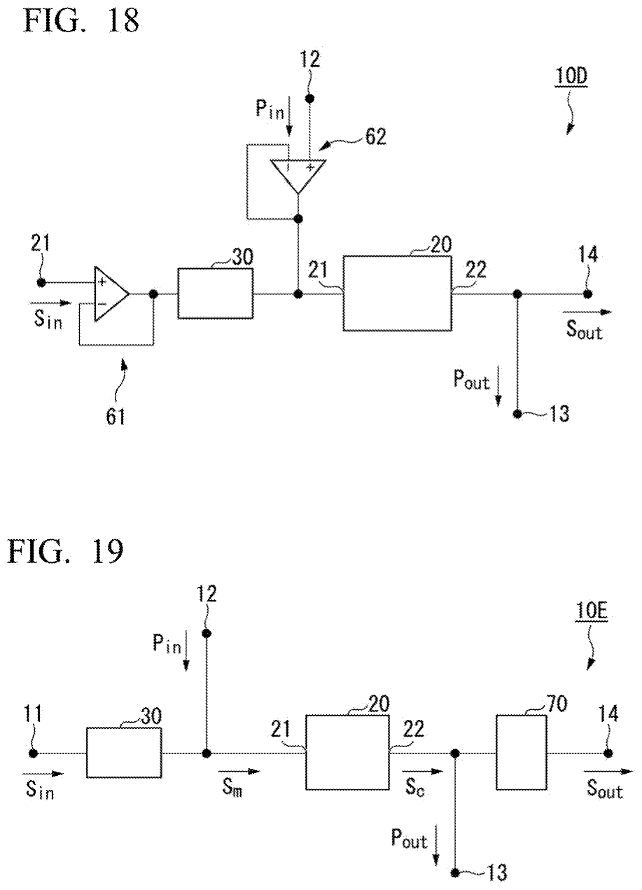

FIG. 18 is a circuit diagram of a physical reservoir element 10D of a physical reservoir according to a fifth embodiment. The physical reservoir element 10D according to the fifth embodiment can be replaced with the physical reservoir element 10 of the physical reservoir 100 according to the first embodiment. The physical reservoir element 10D is different from the physical reservoir element 10 according to the first embodiment in that voltage follower circuits 61 and 62 are disposed. In the physical reservoir element 10D, the same elements as in the physical reservoir element 10 will be referred to by the same reference signs and description thereof will be omitted.

The voltage follower circuit 61 is disposed between the first input terminal 11 and the nonlinear circuit 30. The voltage follower circuit 61 is an example of a first voltage follower circuit. The voltage follower circuit 62 is disposed between the second input terminal 12 and the first terminal 21 of the sample-and-hold circuit 20. The voltage follower circuit 62 is an example of a second voltage follower circuit. The voltage follower circuit 62 may be disposed between the first output terminal 13 and the second terminal 22 of the sample-and-hold circuit 20.

The voltage follower circuits 61 and 62 separate influences in impedance between the circuits. When the physical reservoir includes the voltage follower circuits 61 and 62, it is possible to separate the circuits and to exclude influences in impedance between the circuits. It is possible to curb feedback of a signal from a physical reservoir element 10D in a subsequent stage in a signal propagating direction and to reduce noise of the signal Pₒᵤₜ.

The physical reservoir element 10D can include at least one of the voltage follower circuit 61 and the voltage follower circuit 62.

The physical reservoir according to the fifth embodiment has excellent short term memory property similarly to the physical reservoir 100 according to the first embodiment.

The physical reservoir element 10D according to the fifth embodiment can also employ the same modified examples as in the physical reservoir element 10 according to the first embodiment. To the physical reservoir element 10D according to the fifth embodiment, the nonlinear circuit 31 according to the second embodiment may be applied, the sample-and-hold circuit 40 according to the third embodiment may be applied, the output adjusting unit 50 according to the fourth embodiment may be applied, or a combination thereof may be applied.

### Sixth Embodiment

FIG. 19 is a circuit diagram of a physical reservoir element 10E of a physical reservoir according to a sixth embodiment. The physical reservoir element 10E according to the sixth embodiment can be replaced with the physical reservoir element 10 of the physical reservoir 100 according to the first embodiment. The physical reservoir element 10E is different from the physical reservoir element 10 according to the first embodiment in that an output circuit 70 is disposed. In the physical reservoir element 10E, the same elements as in the physical reservoir element 10 will be referred to by the same reference signs and description thereof will be omitted.

The output circuit 70 includes, for example, a switch. The switch switches connection between the second terminal 22 and the second output terminal 14. When the switch is turned on, an output signal Sₒᵤₜ is output from the second output terminal 14 to the read-out 3. When the switch is turned off, an output signal Sₒᵤₜ is not output from the second output terminal 14 to the read-out 3.

The output circuit 70 may include a voltage follower circuit. The voltage follower circuit included in the output circuit 70 is an example of a third voltage follower circuit. When the output circuit 70 includes the voltage follower circuit, it is possible to exclude an influence in impedance between the read-out 3 and the physical reservoir element 10E.

The output circuit 70 may include an amplifier. The amplifier amplifies the intensity of a signal output to the read-out.

The physical reservoir according to the sixth embodiment has excellent short term memory property similarly to the physical reservoir 100 according to the first embodiment.

The physical reservoir element 10E according to the sixth embodiment can also employ the same modified examples as in the physical reservoir element 10 according to the first embodiment. To the physical reservoir element 10E according to the sixth embodiment, the nonlinear circuit 31 according to the second embodiment may be applied, the sample-and-hold circuit 40 according to the third embodiment may be applied, the output adjusting unit 50 according to the fourth embodiment may be applied, the voltage follower circuits 61 and 61 according to the fifth embodiment may be applied, or a combination thereof may be applied.

### Seventh Embodiment

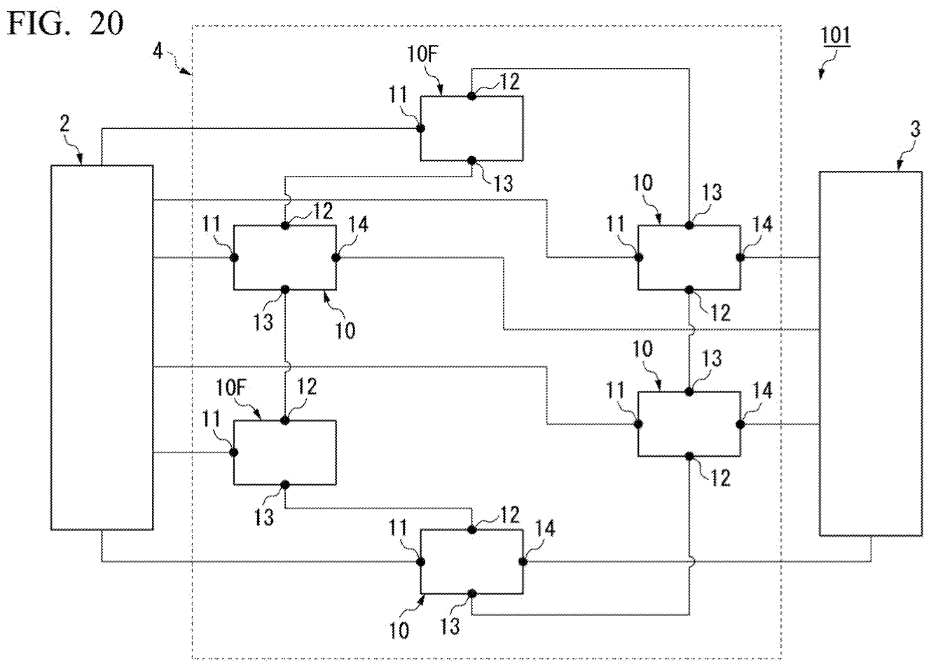

FIG. 20 is a diagram illustrating a configuration of a physical reservoir 101 according to a seventh embodiment. The physical reservoir 101 includes a reservoir 4, an input unit 2, and a read-out 3. The reservoir 4 is different from the reservoir 1 according to the first embodiment in that some of a plurality of physical reservoir elements are a physical reservoir element 10F. In the seventh embodiment, the same elements as in the first embodiment will be referred to by the same reference signs.

The reservoir 4 includes a plurality of physical reservoir elements 10 and at least one physical reservoir element 10F. Which of the physical reservoir elements of the reservoir 4 is realized as the physical reservoir element 10F is arbitrarily determined. The number of physical reservoir elements 10F may be one or two or more.

The physical reservoir element 10F is different from the physical reservoir element 10 in that the second output terminal 14 is not disposed. The physical reservoir element 10F may be obtained by excluding the second output terminal 14 from the physical reservoir elements according to the second to sixth embodiments. The aforementioned modified examples can be applied to the physical reservoir element 10F.

The physical reservoir element 10F functions as an interaction of a signal between the physical reservoir element 10 or the physical reservoir element 10F connected to the second input terminal 12 and the physical reservoir element 10 or the physical reservoir element 10F connected to the first output terminal 13.

The physical reservoir 101 according to the seventh embodiment realizes a neural network using a physical circuit similarly to the physical reservoir 100 according to the first embodiment. The physical reservoir elements 10 and the physical reservoir element 10F include the sample-and-hold circuit 20 and thus have excellent short term memory property.

### Eighth Embodiment

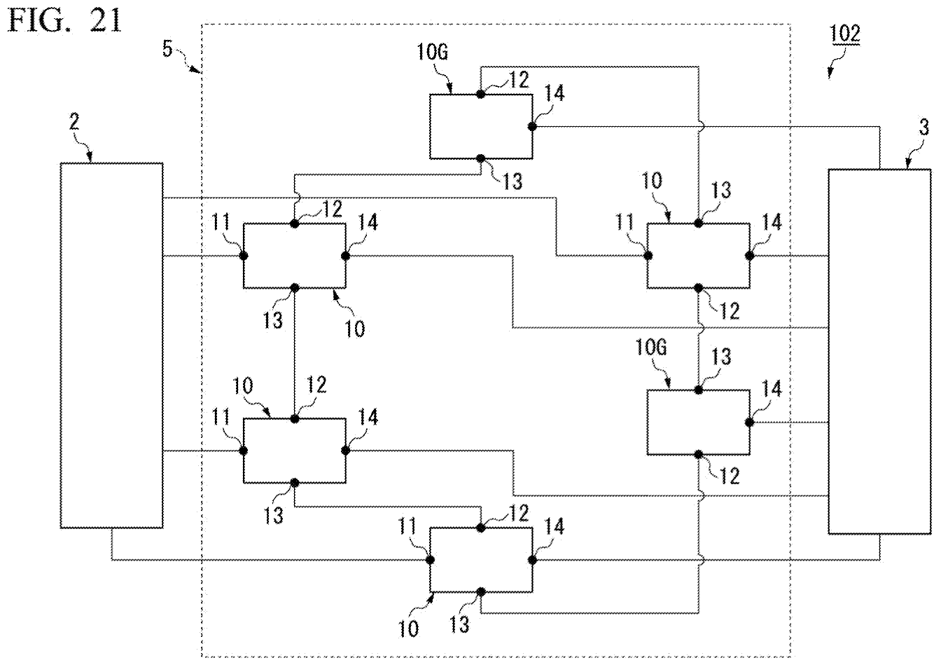

FIG. 21 is a diagram illustrating a configuration of a physical reservoir 102 according to an eighth embodiment. The physical reservoir 102 includes a reservoir 5, an input unit 2, and a read-out 3. The reservoir 5 is different from the reservoir 1 according to the first embodiment in that some of a plurality of physical reservoir elements are a physical reservoir element 10G. In the eighth embodiment, the same elements as in the first embodiment will be referred to by the same reference signs.

The reservoir 5 includes a plurality of physical reservoir elements 10 and at least one physical reservoir element 10G. Which of the physical reservoir elements of the reservoir 5 is realized as the physical reservoir element 10G is arbitrarily determined. The number of physical reservoir elements 10G may be one or two or more.

The physical reservoir element 10G is different from the physical reservoir element 10 in that the first input terminal 11 is not disposed. The physical reservoir element 10G may be obtained by excluding the first input terminal 11 from the physical reservoir elements according to the second to sixth embodiments. The aforementioned modified examples can be applied to the physical reservoir element 10G.

The physical reservoir element 10G holds and converts a signal Pᵢₙ using the sample-and-hold circuit 20 of the physical reservoir element 10G.

The physical reservoir 102 according to the eighth embodiment realizes a neural network using a physical circuit similarly to the physical reservoir 100 according to the first embodiment. The physical reservoir elements 10 and the physical reservoir element 10G include the sample-and-hold circuit 20 and thus have excellent short term memory property.

### Ninth Embodiment

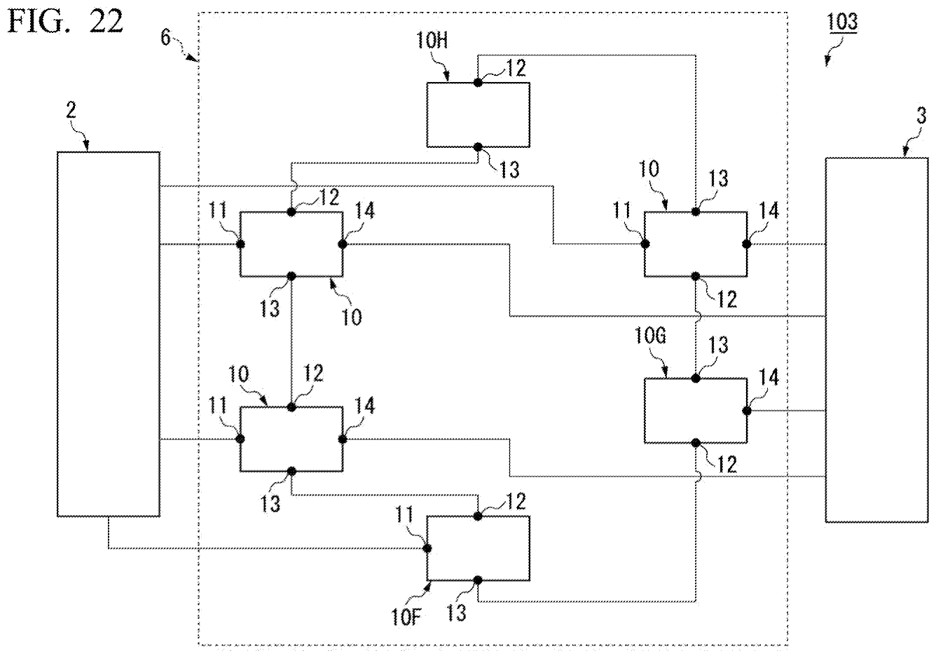

FIG. 22 is a diagram illustrating a configuration of a physical reservoir 103 according to a ninth embodiment. The physical reservoir 103 includes a reservoir 6, an input unit 2, and a read-out 3. The reservoir 6 is different from the reservoir 1 according to the first embodiment in that some of a plurality of physical reservoir elements are a physical reservoir element 10F, a physical reservoir element 10G, and a physical reservoir element 10H. In the ninth embodiment, the same elements as in the first embodiment will be referred to by the same reference signs.

The reservoir 6 includes a plurality of physical reservoir elements 10, at least one physical reservoir element 10F, at least one physical reservoir element 10G, and at least one physical reservoir element 10H. Which of the physical reservoir elements of the reservoir 6 is realized as the physical reservoir element 10F, the physical reservoir element 10G, or the physical reservoir element 10H is arbitrarily determined. The number of physical reservoir elements 10F, the number of physical reservoir elements 10G, and the number of physical reservoir elements 10H may be one or two or more.

The physical reservoir element 10H is different from the physical reservoir element 10 in that the first input terminal 11 and the second output terminal 14 are not disposed. The physical reservoir element 10H may be obtained by excluding the first input terminal 11 and the second output terminal 14 from the physical reservoir elements according to the second to sixth embodiments. The aforementioned modified examples can be applied to the physical reservoir element 10H.

The physical reservoir element 10H functions as an interaction of a signal between one of the physical reservoir element 10, the physical reservoir element 10F, the physical reservoir element 10G, and the physical reservoir element 10H connected to the second input terminal 12 and one of the physical reservoir element 10, the physical reservoir element 10F, the physical reservoir element 10G, and the physical reservoir element 10H connected to the first output terminal 13.

The physical reservoir 103 according to the ninth embodiment realizes a neural network using a physical circuit similarly to the physical reservoir 100 according to the first embodiment. The physical reservoir elements 10, the physical reservoir element 10F, the physical reservoir element 10G, and the physical reservoir element 10H include the sample-and-hold circuit 20 and thus have excellent short term memory property.

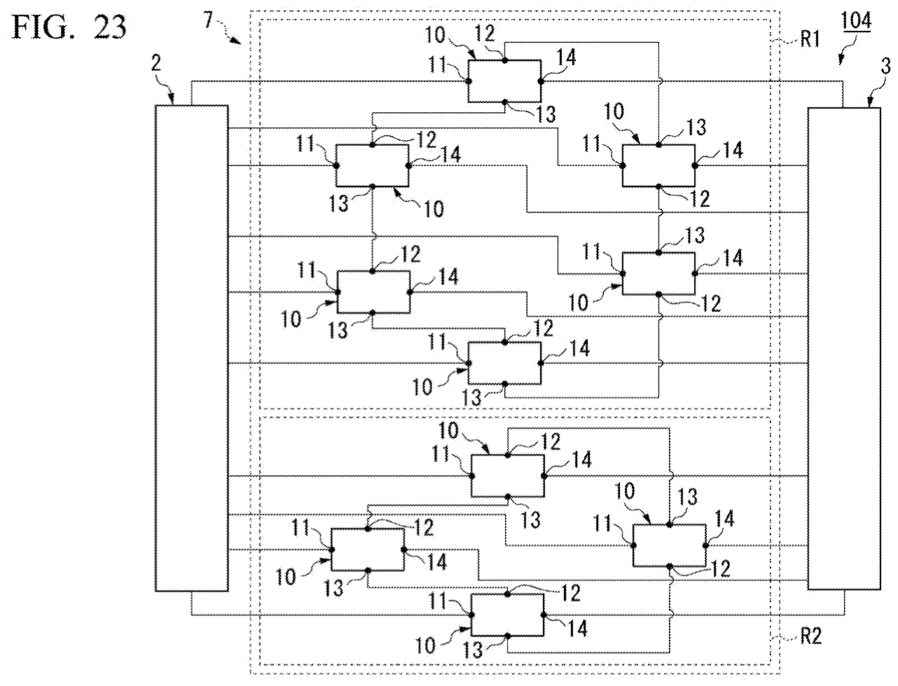

“Tenth embodiment” FIG. 23 is a diagram illustrating a configuration of a physical reservoir 104 according to a tenth embodiment. The physical reservoir 104 includes a reservoir 7, an input unit 2, and a read-out 3. The reservoir 7 is different from the reservoir 1 according to the first embodiment in that a plurality of physical reservoir elements 10 form a plurality of rings. In the tenth embodiment, the same elements as in the first embodiment will be referred to by the same reference signs.

The reservoir 7 includes a first ring unit R1 and a second ring unit R2. In the first ring unit R1, a plurality of physical reservoir elements 10 are connected in a ring shape by a line connecting the second input terminal 12 and the first output terminal 13. Similarly, in the second ring unit R2, a plurality of physical reservoir elements 10 are connected in a ring shape by a line connecting the second input terminal 12 and the first output terminal 13. The numbers of physical reservoir elements 10 constituting the first ring unit R1 and the second ring unit R2 are not particularly limited.

An input signal input to the physical reservoir elements 10 in the first ring unit R1 and an input signal input to the physical reservoir elements 10 in the second ring unit R2 may be the same or different from each other. For example, when there are two types of input signals, a first input signal is input as an input signal Sᵢₙ to the physical reservoir elements 10 in the first ring unit R1 and a second input signal may be input as an input signal Sᵢₙ to the physical reservoir elements 10 in the second ring unit R2, or the first input signal and the second input signal may be input as input signals Sᵢₙ to the physical reservoir elements 10 in each of the first ring unit R1 and the second ring unit R2.

The configuration of each physical reservoir element 10 in the first ring unit R1 and the configuration of each physical reservoir element 10 in the second ring unit R2 may be the same or different from each other. The configuration of a physical reservoir element 10 includes, for example, a capacitance of a capacitor, a first clock signal CLK1 input to the first switch 23, and a second clock signal CLK2 input to the second switch 24. By changing the configurations of the physical reservoir elements 10 in the first ring unit R1 from the second ring unit R2, it is possible to extract different features from the same input signal.

In the example illustrated in FIG. 23, the first ring unit R1 and the second ring unit R2 are connected to the same read-out 3, but the first ring unit R1 and the second ring unit R2 may be connected to different read-outs 3. In this case, the physical reservoir 104 may output a linear sum of an output from the read-out 3 connected to the first ring unit R1 and an output from the read-out 3 connected to the second ring unit R2.

The physical reservoir 104 according to the tenth embodiment realizes a neural network using a physical circuit similarly to the physical reservoir 100 according to the first embodiment and has excellent short term memory property. The physical reservoir 104 according to the tenth embodiment includes a plurality of units in the reservoir 7 and thus can extract various features.

In the physical reservoir 104 according to the tenth embodiment, the physical reservoir element 10 can be replaced with a physical reservoir element according to the aforementioned modified examples or other embodiments.

### Eleventh Embodiment

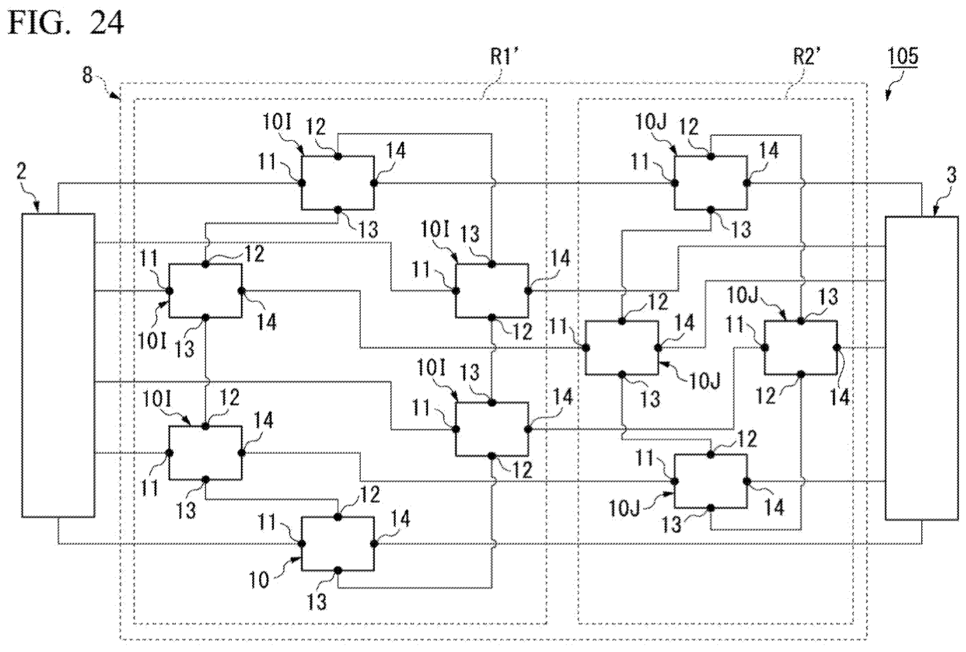

FIG. 24 is a diagram illustrating a configuration of a physical reservoir 105 according to an eleventh embodiment. The physical reservoir 105 includes a reservoir 8, an input unit 2, and a read-out 3. The reservoir 8 is different from the reservoir 1 according to the first embodiment in that a plurality of physical reservoir elements 10 form a plurality of rings. In the eleventh embodiment, the same elements as in the first embodiment will be referred to by the same reference signs.

The reservoir 8 includes a first ring unit R1′ and a second ring unit R2′. In the first ring unit R1′, a plurality of physical reservoir elements 10 or a plurality of physical reservoir elements 10I are connected in a ring shape by a line connecting the second input terminal 12 and the first output terminal 13. Similarly, in the second ring unit R2′, a plurality of physical reservoir elements 10 or a plurality of physical reservoir elements 10J are connected in a ring shape by a line connecting the second input terminal 12 and the first output terminal 13. The number of physical reservoir elements 10, the number of physical reservoir elements 10I, and the number of physical reservoir elements 10J constituting the first ring unit R1′ and the second ring unit R2′ are not particularly limited.

The physical reservoir element 10I has the same configuration as the physical reservoir element 10. The physical reservoir element 10I is different from the physical reservoir element 10 in that the second output terminal 14 is configured to be connectable to the first input terminal 11 of another physical reservoir element 10J.

The physical reservoir element 10J has the same configuration as the physical reservoir element 10. The physical reservoir element 10J is different from the physical reservoir element 10 in that the first input terminal 11 is configured to be connectable to the second output terminal 14 of another physical reservoir element 10I.

The first ring unit R1′ and the second ring unit R2′ are formed in a hierarchical shape, the first ring unit R1′ functions as a first-half process of the reservoir 8, and the second ring unit R2′ functions as a second-half process of the reservoir 8.

The configuration of each physical reservoir element 10 or each physical reservoir element 10I in the first ring unit R1′ and the configuration of each physical reservoir element 10 or each physical reservoir element 10J in the second ring unit R2′ may be the same or different from each other. By changing the configurations of the physical reservoir elements in the first ring unit R1′ and the second ring unit R2′, it is possible to enhance an expressive ability of the reservoir 8 and to perform more complex processes. The reservoir 8 can form a feature space with a high expressive ability more suitable for a target task.

The physical reservoir 105 according to the eleventh embodiment realizes a neural network using a physical circuit similarly to the physical reservoir 100 according to the first embodiment and has excellent short term memory property. The physical reservoir 105 according to the eleventh embodiment includes a plurality of units in the reservoir 8 and thus can more enhance the expressive power of the reservoir 8.

In the physical reservoir 105 according to the eleventh embodiment, the physical reservoir element 10 can be replaced with a physical reservoir element according to the aforementioned modified examples or other embodiments. The same modifications as the physical reservoir element 10 can also be applied to the physical reservoir element 10I and the physical reservoir element 10J. The physical reservoir 105 according to the eleventh embodiment may include a plurality of ring units in parallel similarly to the tenth embodiment.

### Twelfth Embodiment

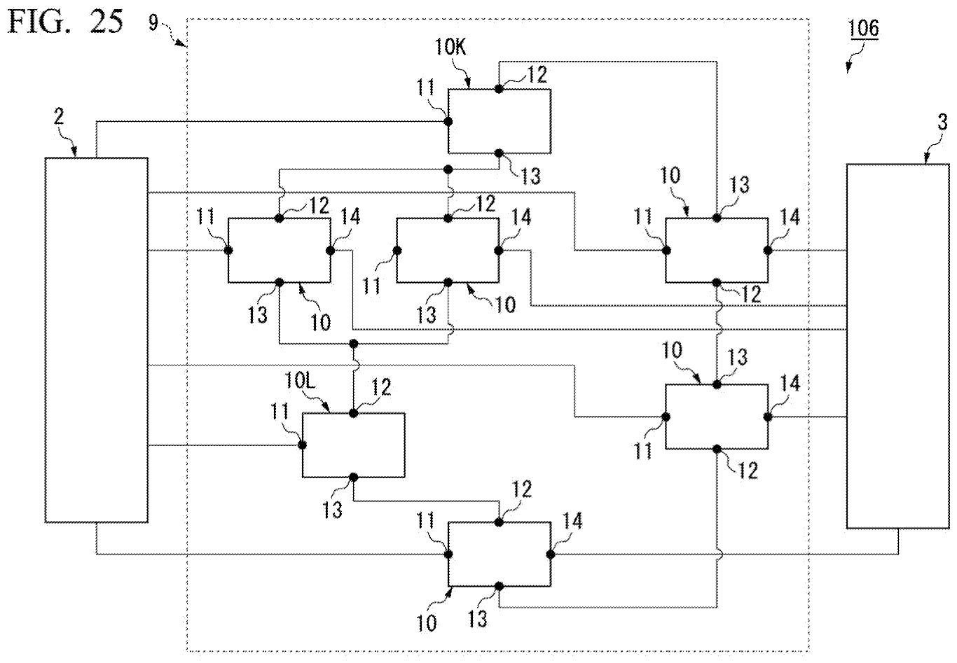

FIG. 25 is a diagram illustrating a configuration of a physical reservoir 106 according to a twelfth embodiment. The physical reservoir 106 includes a reservoir 9, an input unit 2, and a read-out 3. The reservoir 9 is different from the reservoir 1 according to the first embodiment in that some of a plurality of physical reservoir elements 10 are connected to a plurality of physical reservoir elements 10. In the twelfth embodiment, the same elements as in the first embodiment will be referred to by the same reference signs.

The reservoir 9 includes a plurality of physical reservoir elements 10, at least one physical reservoir element 10K, and at least one physical reservoir element 10L. The first output terminal 13 of the physical reservoir element 10K is configured to be connectable to a plurality of physical reservoir elements 10. The second input terminal 12 of the physical reservoir element 10L is configured to be connectable to a plurality of physical reservoir elements 10. The configurations of the physical reservoir element 10K and the physical reservoir element 10L are the same as the physical reservoir element 10.

The physical reservoir 106 according to the twelfth embodiment realizes a neural network using a physical circuit similarly to the physical reservoir 100 according to the first embodiment and has excellent short term memory property. In the physical reservoir 106 according to the twelfth embodiment, connections among the physical reservoir elements 10, the physical reservoir elements 10K, and the physical reservoir elements 10L in the reservoir 9 are more complex, and thus it is possible to further enhance an expressive ability of the reservoir 9.

In the physical reservoir 106 according to the twelfth embodiment, the physical reservoir element 10 can be replaced with a physical reservoir element according to the aforementioned modified examples or other embodiments. The same modifications as the physical reservoir element 10 can also be applied to the physical reservoir element 10K and the physical reservoir element 10L. The physical reservoir 106 according to the twelfth embodiment may include a plurality of ring units in the reservoir 9.

The physical reservoirs according to the first embodiment and the seventh to twelfth embodiments may be used alone or two or more thereof may be combined. For example, a plurality of physical reservoirs may be connected in series. In this case, the read-out 3 of the physical reservoir in a previous stage and the input unit 2 of the physical reservoir in a subsequent stage are connected. Each of the plurality of physical reservoirs may be one of the physical reservoirs according to the first embodiment and the seventh to twelfth embodiments.

### EXPLANATION OF REFERENCES

1, 4, 5, 6, 7, 8, 9 . . . Reservoir
2 . . . Input unit
3 . . . Read-out
10, 10A, 10B, 10C, 10D, 10E, 10F, 10G, 10H, 10I, 10J, 10K, 10L . . . Physical reservoir element
11 . . . First input terminal
12 . . . Second input terminal
13 . . . First output terminal
14 . . . Second output terminal
20, 20A, 20B, 20C . . . Sample-and-hold circuit
21 . . . First terminal
22 . . . Second terminal
23 . . . First switch
24 . . . Second switch
25 . . . First capacitor
25A . . . First conductive layer
25B . . . Second conductive layer
25C . . . Capacitance layer
25D . . . First electrode
25E . . . Second electrode
25F . . . Third electrode
25G . . . Insulating layer
27 . . . Inverter
28 . . . Voltage follower circuit
29 . . . Switch
30, 31 . . . Nonlinear circuit
40 . . . Sample-and-hold circuit
50 . . . Output adjusting unit
61, 62 . . . Voltage follower circuit
70 . . . Output circuit
100, 101, 102, 103, 104, 105, 106 . . . Physical reservoir
200, 200A . . . Information processing device
201 . . . Physical reservoir
202 . . . Processor
203 . . . Memory
204 . . . Communication device
205 . . . Bus
CLK1 . . . First clock signal
CLK2 . . . Second clock signal
CTL1 . . . First control signal
CTL2 . . . Second control signal
Pᵢₙ, Pₒᵤₜ . . . Signal
Sᵢₙ . . . Input signal
Sₒᵤₜ . . . Output signal
S₁ . . . First signal
S₂ . . . Second signal

What is claimed is:

1. A physical reservoir element comprising a first input terminal, a second input terminal, a first sample-and-hold circuit, a first output terminal, and a first nonlinear circuit,
wherein the first input terminal is configured to be connectable to an input source for transmitting an input signal to the physical reservoir,
wherein the second input terminal is configured to be connectable to one or more other physical reservoir elements,
wherein the first nonlinear circuit is disposed between the first input terminal and the first sample-and-hold circuit,
wherein a first terminal of the first sample-and-hold circuit is configured to receive a joined signal which is obtained by joining signals from the first input terminal and the second input terminal,
wherein a second terminal of the first sample-and-hold circuit is connected to the first output terminal,
wherein the first output terminal is configured to be connectable to one or more other physical reservoir elements, and
wherein the first sample-and-hold circuit holds and converts the joined signal.

2. The physical reservoir element according to claim 1, further comprising a second output terminal connected to the second terminal,
wherein the second output terminal is configured to be connectable to a read-out for outputting a signal to the outside of the physical reservoir.

3. The physical reservoir element according to claim 1, further comprising a second nonlinear circuit,
wherein the second nonlinear circuit is disposed between the second input terminal and the first sample-and-hold circuit.

4. The physical reservoir element according to claim 1, further comprising a second sample-and-hold circuit,
wherein the second sample-and-hold circuit is disposed between the second terminal of the first sample-and-hold circuit and the first output terminal.

5. The physical reservoir element according to claim 1, further comprising a resistor,
wherein the resistor is disposed between the second terminal of the first sample-and-hold circuit and the first output terminal.

6. The physical reservoir element according to claim 1, further comprising a gain adjustment circuit,
wherein the gain adjustment circuit is disposed between the second terminal of the first sample-and-hold circuit and the first output terminal.

7. The physical reservoir element according to claim 1, further comprising a first voltage follower circuit,
wherein the first voltage follower circuit is disposed between the first input terminal and the first nonlinear circuit.

8. The physical reservoir element according to claim 1, further comprising a second voltage follower circuit,
wherein the second voltage follower circuit is disposed between the second input terminal and the first nonlinear circuit or between the first sample-and-hold circuit and the first output terminal.

9. The physical reservoir element according to claim 2, further comprising a third voltage follower circuit,
wherein the third voltage follower circuit is disposed between the first sample-and-hold circuit and the second output terminal.

10. A physical reservoir comprising a plurality of physical reservoir elements, wherein at least one of the plurality of physical reservoir elements is the physical reservoir element according to claim 1.

11. The physical reservoir according to claim 10, wherein at least some of the plurality of physical reservoir elements are connected in a ring shape.

12. The physical reservoir according to claim 11, further comprising a plurality of physical reservoir units in which the plurality of physical reservoir elements are connected in a ring shape,
wherein at least two of the plurality of physical reservoir units are connected in series or in parallel.

13. The physical reservoir according to claim 10, wherein each of the plurality of physical reservoir elements includes the first nonlinear circuit, and
wherein nonlinear characteristics of the first nonlinear circuit in at least one of the plurality of physical reservoir elements are different from nonlinear characteristics of the first nonlinear circuit in the other physical reservoir elements of the plurality of physical reservoir elements.

14. An information processing device comprising the physical reservoir according to claim 10.
